(19) United States
(12) Patent Application Publication
(10) Pub. No.: US 2003/0051945 A1
(43) Pub. Date: Mar. 20, 2003

(54) Method for purchasing consumer products

(76) Inventors: Deborah Marie Coccaro, Colonia, NJ (US); John Michael Paulovich, Hewitt, NJ (US); Edward John Giblin, Hopatcong, NJ (US)

Correspondence Address: UNILEVER, PATENT DEPARTMENT, 45 RIVER ROAD, EDGEWATER, NJ, 07020, US

(21) Appl. No.: 09/955,894

(22) Filed: Sep. 19, 2001

(51) Int. Cl. B61B 1/00; B65G 1/00; E04H 3/00

(52) U.S. Cl. 186/52

(57) ABSTRACT

The present invention is directed to a method for purchasing a consumer product. Particularly, a consumer purchases a consumer product in a package that may be refilled a predetermined number of times. The method generates less environmental waste, and allows the consumer to purchase consumer products at reduced costs.

### FIELD OF THE INVENTION

The present invention is directed to a method for purchasing a consumer product. More particularly, the present invention is directed to a method for purchasing a consumer product whereby a consumer refills, or has refilled, a refillable package at a point of purchase establishment. The method of the present invention generates less environmental waste, and allows the consumer to purchase consumer products at reduced costs.

### BACKGROUND OF THE INVENTION

Many consumer products are sold in packages such as bottles, bags and boxes. Typically, the consumer purchases the packaged consumer product and discards the bottle, sachet, bag or box, as the case may be, after the consumer product has been used. As can be appreciated, many households generate excessive waste in the form of packages. Moreover, additional waste is generated when such packages are transported in cartons or crates (i.e., secondary packaging) that must be shipped to point of purchase establishments and subsequently discarded.

In addition to waste generation, consumer product packages can be very expensive. In fact, it is well known that a package may cost as much as or more than the consumer product it actually carries. Thus, in order to make acceptable profits, consumer product companies are forced to pass the cost of the packaging onto the consumer.

It is of increasing interest to develop a method for doing business that does not generate excessive waste and does not result in the consumer having to pay additional costs for desired consumer goods.

This invention, therefore, is directed to a method for purchasing consumer products wherein the method generates less environmental waste and simultaneously minimizes packaging costs that are typically passed onto the consumer. Such a business method is achieved by selling a refillable package to the consumer and establishing product refilling means at point of purchase establishments.

Additional Information

Efforts have been disclosed for dispensing a beverage. In U.S. patent application Ser. No. 2001/0013524 A1, a beverage server and brewer is described.

Other efforts have been disclosed for dispensing a highly viscous liquid. In U.S. Pat. No. 6,289,837, a rechargeable dispensing system is disclosed.

Still other efforts have been disclosed for dispensing dyestuffs and paints. in U.S. Pat. No. 6,269,978, a dispensing and dosing machine for dyestuffs is disclosed.

None of the information above describes a method for purchasing consumer products that results in less environmental waste and reduced costs for consumers.

### SUMMARY OF THE INVENTION

In a first aspect, the present invention is directed to a method for purchasing a consumer product comprising the steps of:

(a) selling a consumer product in a package to a consumer at a point of purchase establishment;

(b) instructing the consumer to retain the package after the consumer product has been consumed; and

(c) providing a means for the consumer to have the package refilled with consumer product.

In a second aspect, the present invention is directed to a method for purchasing a consumer product comprising the steps of:

(a) selling a consumer product in a package to a consumer at a point of purchase establishment;

(b) instructing the consumer to retain the package after the consumer product has been consumed; and

(c) providing a means for the consumer to have the package refilled for a predetermined number of times

wherein the consumer product is selected from the group consisting of a laundry detergent and fabric softener.

### BRIEF DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 depicts a package which may be refilled and used with the method for purchasing a consumer product as described herein; and

FIG. 2 depicts a refilling device for refilling the package with a consumer product.

### DETAILED DESCRIPTION OF THE PREFERRED EMBODIMENTS

There is no limitation with respect to the consumer product that may be sold via the method of this invention other than that the consumer product is one which is generally made available at a point of purchase establishment. Such consumer products include, but are not limited to, cereals, shampoos, hair conditioners, beverages, creams and ointments, laundry detergents and fabric softeners. In a preferred embodiment, however, the consumer product sold by the method of the present invention is a laundry detergent or a fabric softener and often not a beverage like bottled water. In an especially preferred embodiment, the consumer product sold via the method of the present invention is a laundry detergent, such as Wisk®, all® or Surf®, or a fabric softener like Snuggle®, all of which are made commercially available by Unilever HPC.

The form of the consumer product which may be sold pursuant to this invention is limited only to the extent that the consumer product may be refilled in a refillable package. Thus, the consumer product may be in the form of a flake, granule, tablet, powder, paste, slurry or liquid. In a preferred embodiment, however, the consumer product is in the form of a powder or liquid; and most preferably, a liquid.

The package that may be used in this invention is limited only to the extent that it may hold, carry or contain a consumer product, and be refilled. Such a package can be a bottle, bag, sachet or box. In a preferred embodiment, the package is a box or a bottle. In a most preferred embodiment, the package is a bottle such as the type that is used to carry a liquid laundry detergent or a liquid fabric softener.

The point of purchase establishment where a consumer may use the method for purchasing a consumer product of this invention is limited only to the extent that it is the type of establishment that typically sells consumer products. Such a point of purchase establishment is often a mini-mart, department store, club-store or supermarket; and preferably, a supermarket.

Regarding the means for the consumer to have the package refilled, often the package comprises an information device that provides information in computer readable form via, for example, a bar code label, laser code label, a chip, magnetic strip, a radio frequency identification transponder (e.g., RF tag) or the like. The instructions for the consumer regarding the refilling of the package can, for example, be printed directly on the package, on a label on the package, or on a printout sold with the package.

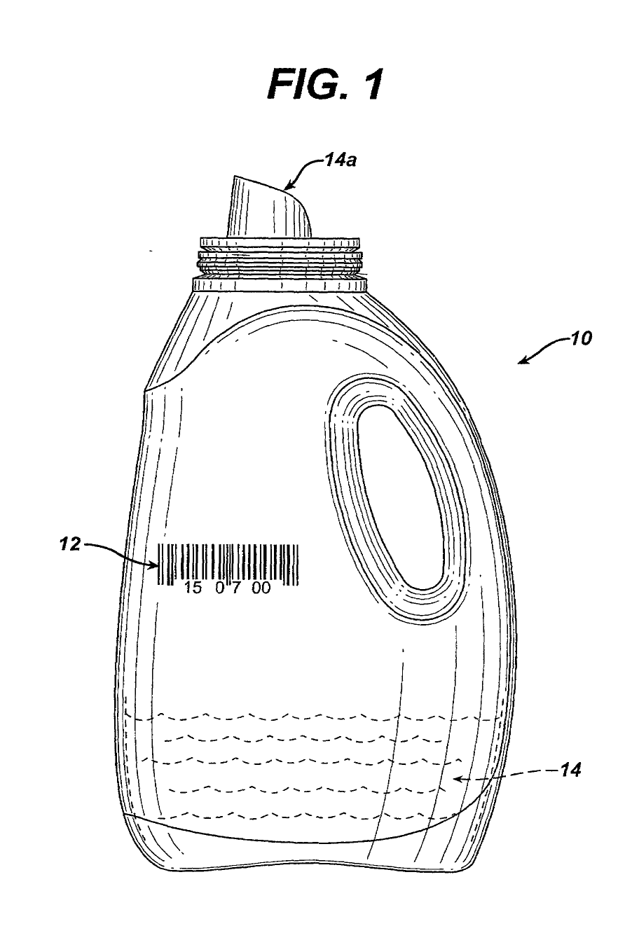

As shown in FIG. 1, an illustrative package 10 (in the form of a bottle) has an information device 12 (in the form of a bar code label). The information device 12 comprises information about the product 14 (including the volume of product 14 that should go into the package 10 and/or the size of the package 10) and information regarding how many times the package 10 may be refilled with product 14. The information about the product 14 defines or identifies the product 14 as, for example, a laundry detergent, fabric softener or shampoo composition, including any variations thereof. Information regarding how many times the package 10 may be refilled with product 14 means that the package 10 may be refilled a predetermined number of times. Typically, the predetermined number of times is a number of times that ensures that no stress fractures will form in the package 10 as a result of the package being used more than one time. Preferably, however, the package 10 is not refilled over twenty (20) times; most preferably, not refilled over ten (10) times. The product 14 may be refilled in to the package 10 through opening or spout 14a which is capped with a cap (not shown) when the package 10 is not being refilled and when a consumer is not in need of product 14.

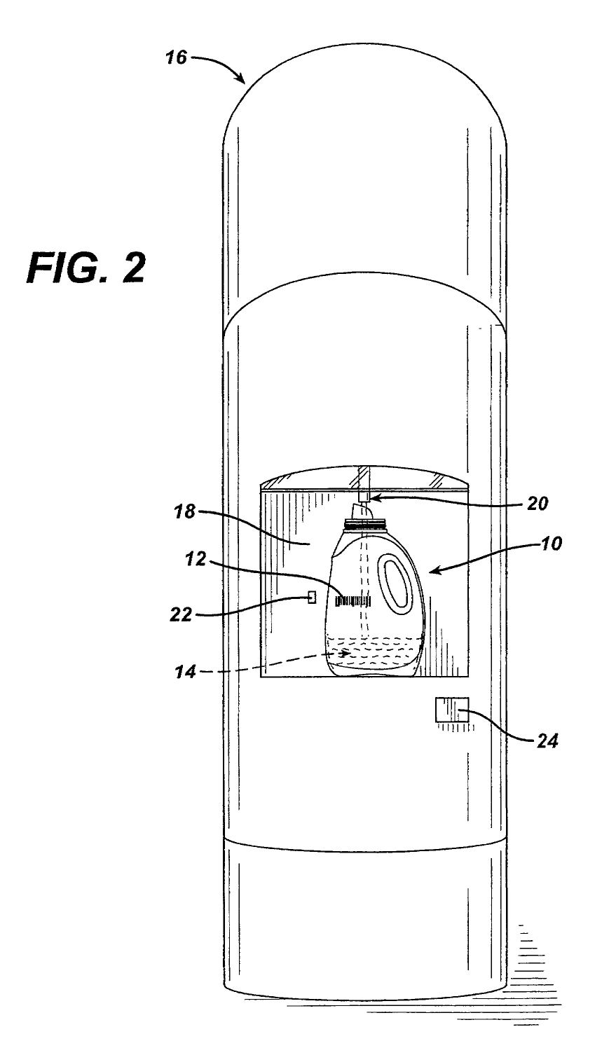

When the package 10 is deplete of consumer product 14, the consumer may bring the package 10 back to a point of purchase establishment. At the point of purchase establishment, the consumer can have the package 10 refilled or the consumer may refill the package 10 himself/herself. Turning to FIG. 2, an illustrative refilling device 16 is shown. The refilling device 16 (which has a refillable product tank, not shown) has a refill space 18 to place or hold package 10 when refilling. Product 14 is fed into package 10 by way of refilling nozzle 20. The type and amount of product 14 being fed into the package 10 is provided to the refilling device 16 by way of information detector 22 which is activated by control panel 24 and which reads the information on information device 12. After product 14 is fed into package 10. via opening or spout 14a, the consumer may. then take the package 10 and cap it for transport to the venue of use. Information regarding how many times the package 10 has been filled and how many more refills remain is then stored in a computer, not shown, in direct association with the information detector. It is also noted, that if desired, the refilling device 16 can be modified to not send product ready for use into the package 10 but to send product in the form of concentrate into the package 10 which may be diluted with water by the consumer or by the refilling device 16.

As previously mentioned, refilling device 16 is an illustrative device that may be used for refilling consumer product in to a package. It is within the scope of this invention, however, to employ any type of device to refill the package as described herein, as long as the device can dispense consumer product and can be used in a point of purchase establishment. Such refilling devices may be made by conventional dispensing system suppliers like Liqui-Box Corporation and Tridak-A Division of Indicon. Moreover, the information device 12 which may be used in this invention is typically made available from suppliers like Logic Controls, Inc., Vanguard ID Systems and Metrologic Instruments, Inc. Such information devices and systems having the same are described in U.S. Pat. No. 6,286,760 B1, the disclosure of which is incorporated by reference. Additional packages and systems which may be used in this invention may be found in Provisional Application Docket No. 01-D516-EDG, the disclosure of which is incorporated herein by reference.

When carrying out the method for purchasing consumer products as described in this invention, the consumer may purchase the product 14 in package 10, via conventional purchasing means at a point of purchase establishment. After utilizing the product 14, the consumer may return to the point of purchase establishment, refill the package 10 with the product 14 and pay for the refill at a price which is less than the price for product 14 in a new package (i.e.. not being refilled). A consumer may also purchase an empty package 10 that has, included within its sale price, a predetermined number of refills.

Moreover, it is also, for example, within the scope of this invention, for the consumer to purchase a product 14 in package 10 at a point of purchase establishment for an original price (P_{O}) that is higher than the typical purchase price (P_{T}) of the product 14 contained in its package 10. Included in the original price (P_{O}) is, however, the typical purchase price (P_{T}) plus the price for a defined number (N) of refills, the refill price (P_{R}). It is noted herein that the original price (P_{O}) which is higher than the typical purchase price (P_{T}) of product 14 in package 10 not only includes the number of refill price (P_{R})_{N}, but it is less than the typical purchase price(P_{T}) plus the price of a defined number (N′) of purchases at the typical purchase price (P_{T}) where:

N=N′

P_{O}=P_{T}+(P_{R})N

P_{O}<P_{T}+(P_{T})N′

Therefore, when the consumer purchases product 14 in a package 10 as described in this invention, less waste (in the form of packaging) is generated and savings are passed onto the consumer.

In the claims:

1. A method for purchasing a consumer product comprising the steps of:
(a) selling a consumer product in a package to a consumer at a point of purchase establishment;
(b) instructing the consumer to retain the package after the consumer product has been consumed; and
(c) providing a means for the consumer to have the package refilled with consumer product.

2. The method for purchasing a consumer product according to claim 1 wherein the consumer product is a cereal, shampoo, hair conditioner, beverage, cream or ointment, laundry detergent or fabric softener.

3. The method for purchasing a consumer product according to claim 1 wherein the consumer product is a laundry detergent or fabric softener.

4. The method for purchasing a consumer product according to claim 1 wherein the point of purchase establishment is a mini-mart, department store, club-store or supermarket.

5. The method for purchasing a consumer product according to claim 1 wherein the package is a bottle, bag, sachet or box.

6. The method for purchasing a consumer product according to claim 1 wherein the package is a bottle for carrying a laundry detergent or fabric softener.

7. The method for purchasing a consumer product according to claim 1 wherein the package is refilled a predetermined number of times, the predetermined number of times being less than a number of times that causes stress fractures in the package.

8. The method for purchasing a consumer product according to claim 1 wherein product is a flake, granule, tablet, powder, paste, slurry or liquid.

9. The method for purchasing a consumer product according to claim 1 wherein the product is a liquid detergent or liquid fabric softener.

10. The method for purchasing a consumer product according to claim 1 wherein the package has an information device and is refilled by being placed in association with a refilling device having an information detector for reading information about the product off of the information device.

11. The method for purchasing a consumer product according to claim 1 wherein the method satisfies the formula P_{O}<P_{T}+(P_{T})N′ where
P_{O}=P_{T}+(P_{R})_{N}
P_{O}=original purchase price of a consumer product;
P_{T}=typical purchase price of a consumer product;
P_{R}=refill price;
N=a defined number of refills;
N′=a defined number of purchases; and
N=N′
and further wherein less environmental waste is generated and the consumer pays less money for the consumer product.

12. The method for purchasing a consumer product according to claim 1 wherein the product is a laundry detergent concentrate.

13. The method for purchasing a consumer product according to claim 1 wherein the product is a fabric softener concentrate.
